(19) United States
(12) Patent Application Publication
(10) Pub. No.: US 2007/0214690 A1
(43) Pub. Date: Sep. 20, 2007

(54) 3-D displays with cohesive zones

(76) Inventor: David A. Pierce, Renton, WA (US)

Correspondence Address: GRAYBEAL, JACKSON, HALEY LLP, 155 - 108TH AVENUE NE, SUITE 350, BELLEVUE, WA, 98004-5973, US

(21) Appl. No.: 11/716,543

(22) Filed: Mar. 9, 2007

Related U.S. Application Data
(63) Continuation of application No. PCT/US05/32212, filed on Sep. 9, 2005.
(60) Provisional application No. 60/609,129, filed on Sep. 9, 2004.

(51) Int. Cl. G09F 1/06

(52) U.S. Cl. 40/124.07; 40/124.01; 40/124.01

(57) ABSTRACT

A display stand, including a flexible and/or segmented blank of material having a first surface, a second surface and a perimeter there between, wherein selected portions of the blank include an adhesive, and preferably a cohesive, selectively applied to areas of the blank to create attachment zones. The attachment zones may be established on selected portions of the first surface, on the entire area of the first surface, or on areas in addition to the first surface. In preferred embodiments, attachment zones are established at opposing ends of the material wherein a self-sustaining display having depth can be achieved by contacting the two attachment zones. Graphics or indicia can be imprinted on the blank of material to further increase the utility of the display stand.

### CROSS-REFERENCE TO RELATED APPLICATION

This is a continuation application claiming benefit, under 35 USC §120, of co-pending International Application PCT/US2005/032212, filed on 9 Sep. 2005, designating the United States, which claimed priority to U.S. Provisional Application No. 60/609,129, filed 9 Sep. 2004, which applications are incorporated herein by reference.

### BACKGROUND OF THE INVENTION

Conventional display stands, and decorative or functional cellulose-based structures, are constructed from a flexible material such as cardboard, chip board and the like, and usually include one or more tab and slot pairs that are intended to facilitate the creation of a three dimensional form after user manipulation. While functional, these displays have certain deficiencies such as the time needed to identify which tab fits into which slot, difficulty associated with insertion of tabs into slots, retention of tabs in slots after manipulation, longevity of the display if subject to repeated assembly and disassembly, cost of production issues, material waste issues, etc.

### SUMMARY OF THE INVENTION

The present invention is directed to an easy-to-assembly display stand for advertising, or decorative/functional cellulose-based structure that requires no insertion of tabs into slots in order to achieve a freestanding three-dimensional form from a generally planar initial form. Embodiments of the invention comprise a flexible and/or segmented blank of material having a first surface, a second surface and a perimeter joining the first and second major surfaces. In addition, embodiments of the invention further comprise selectively applied attachment means to portions thereof, thereby creating attachment zones that function to join one portion of the material to another. The attachment means may be applied to selected portions of the first surface of the material, to the entire area of the first surface of the material, or to areas in addition to the first surface of the material, e.g., the second surface. The selection of area(s) or zone(s) for application of the attachment means is generally driven by the intended shape of the resulting three-dimensional display, assembly requirements, intended ease of assembly, and other similar considerations including manufacturing considerations.

In preferred embodiments, a “cohesive” coating comprises the attachment means; a cohesive selectively bonds generally only to itself (self-adhesive), as opposed to an adhesive, which generally bonds to any coherent material. An advantage of using a cohesive over an adhesive is that a cohesive can be exposed to a host of materials without establishing a bond. Conventional adhesives, however, must rely upon the use of a barrier to prevent unintentional bonding with other materials. Moreover, a cohesive may be applied to areas greater than that sought to function as an attachment zone so precise application and location of the cohesive is not necessary as it would be with most other forms of attachment means. While less preferably, alternative attachment means include, but are not limited to, adhesives (with or without protective release barriers); mechanical fasteners such as staples, rivets and the like; two part fasteners such as hook and loop segments; and other equivalent means well known to those persons skilled in the art.

Various embodiments of the invention use cohesives having differing degrees of bonding aggressiveness. For permanent or single-use structures, a highly aggressive cohesive is preferably used (once bonded, never separated); for multi-use structures, a less aggressive cohesive is preferably used.

Embodiments of the invention further comprise first and second ends in general opposition to each other. Preferably at each end is the previously described attachment zone. The attachment zones may both be on the first surface, both on the second surface, or the first zone on the first surface and the second zone on the second surface (or vice versa), depending upon how the structure is intended to be established. However, it is preferable to have the attachment zones created on a single surface in view of manufacturing economies associated with single side printing and attachment means application, as well as ease of handling. In such cases, it is further desirable to establish a joint segment at the boundary between the attachment zone and the remaining material, in which the attachment means is preferably absent although with use of a cohesive this preference is deminimus. In this manner, the material can be hinged (localized bending) so that the two attachment zones are in opposition, where after they can be contacted with each other to establish a bond, fastening or other linkage.

While many of the embodiments of the invention utilize attachment zones proximate to opposing ends of the material, the invention is not limited to these locations. For example, additional attachment zones may be established on either of the surfaces and receive, upon proper material manipulation, one of the attachment zones proximate to one end of the material or other locations. Common implementations of this approach include involution of one or both ends possessing attachment zones towards a surface having also having an attachment zone. Moreover, if a cohesive is used as the attachment means, one major surface can be entirely coated with the attachment means, and selected portions thereof mated together to form the attachment zones, even though the attachment means includes portions of the material not subject to mating. In other words, the presence of an attachment means at one location of the material does not establish an attachment zone; attachment zones are established by an intended mating of one attachment zone to another.

While the number of geometric forms that can be realized using the invention is nearly limitless, simple embodiments of the invention generally approximate regular or irregular hollow polygonal cylinders when additional joint segments are used. In addition to formation of rectilinear sections from the material, it is also possible to create curvilinear sections from the material. This is possible where the material is bent into at least one arc and the first and second ends bonded or attached to retain the curvilinear form. In addition to the foregoing, it is also within the scope of the invention to join two, three, or more blanks together to arrive at a desired display form, as well as incorporate appendages that may be “tacked” on to the display. Naturally, each point of intended contact comprises an attachment zone having attachment means present thereat.

For applications wherein the structure will receive graphics and/or indicia, the material is further subjected to a conventional printing process. In those applications wherein a cohesive comprises the attachment means, it can beneficially be applied during the printing process. This approach is considered most beneficial where the structure is a visual display board constructed from a cellulose source such as wood pulp. In such applications, the blank can be subject to printing, scoring (for establishing joint segments) and cohesive application in a single operation, thereby significantly reducing manufacturing costs. Moreover, such embodiments can be easily prepared for shipment.

### BRIEF DESCRIPTION OF THE DRAWINGS

FIG. 1 is a perspective view of a first series embodiment of the invention wherein the structure is a display having two cohesive zones in opposition and establishing a curvilinear display;

FIG. 2 is a perspective view of a first series embodiment of the invention wherein the structure is a display having two cohesive zones in opposition and establishing a rectilinear display;

FIG. 3 is a perspective view of a first series embodiment of the invention wherein the structure is a display having two cohesive zones in opposition and establishing a highly faceted rectilinear display;

FIG. 4 is a perspective view of a second series embodiment of the invention wherein the structure is a display having two cohesive zones in involuted opposition and establishing a curvilinear display;

FIG. 5 is a perspective view of the second series embodiment of FIG. 4 but wherein the material has been die cut to create 3-D cut outs to enhance the display;

FIG. 6 is a perspective view of a third series embodiment illustrating the linking of two structures having selectively applied cohesive zones;

FIG. 7 is a perspective view of a generic embodiment of the invention having one side coated with a cohesive, and involuted to form a substantially solid cylinder;

FIG. 8 is a series of perspective views of the involuted embodiment of FIG. 7 being inserted into a cylindrical shipping tube;

FIG. 9 is a perspective view of a fourth series embodiment of the invention wherein a liner side is imprinted with graphics and a fluted side is coated with a cohesive; and

FIGS. 10A-10D illustrate, in perspective views, the assembly of the fourth embodiment of the invention into a 3-D display.

### DESCRIPTION OF THE EMBODIMENTS

The following discussion is presented to enable a person skilled in the art to make and use the invention. Various modifications to the preferred embodiment will be readily apparent to those skilled in the art, and the generic principles herein may be applied to other embodiments and applications without departing from the spirit and scope of the present invention as defined by the appended claims. Thus, the present invention is not intended to be limited to the embodiment show, but is to be accorded the widest scope consistent with the principles and features disclosed herein.

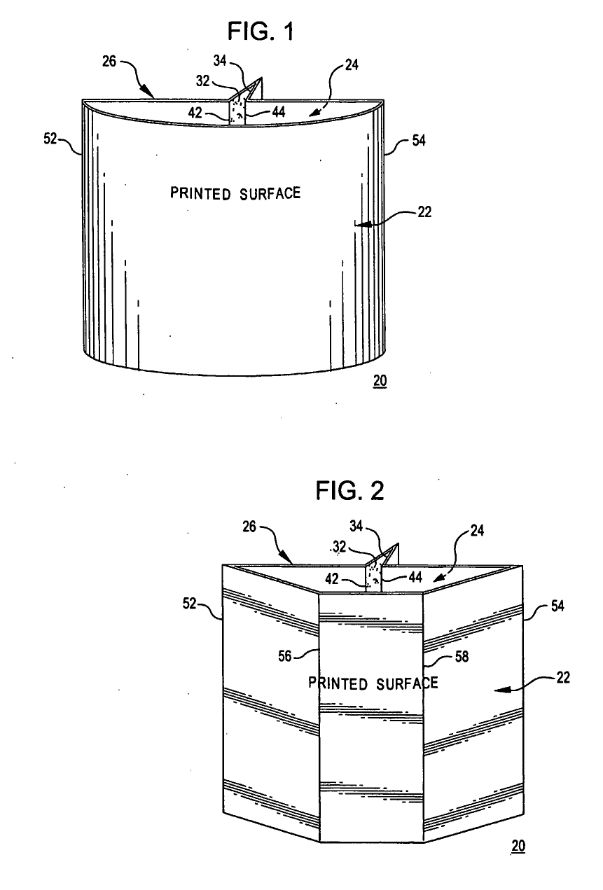

A first series embodiment is shown in FIG. 1. Here, display 20 is preferably constructed from a cardboard blank and has first surface 22, second surface 24, and perimeter or edge 26. A total of four joint segments 42, 44, 52 and 54 have been created in the material such as by scoring or other means sufficient to establish a crease or joint for easy hinged motion. Adjacent to joint segments 42 and 44 are, respectively, cohesive zones 32 and 34 (in all Figures herein, the cohesive zones are shown in opposition just prior to actual contact for clarity). Each cohesive zone is characterized as a portion or zone of display 20 that has present thereon a coating of a latex cohesive, suppliers which can be found at the Thomas Register Directory. As illustrated in the first series embodiments, cohesive zones 32 and 34 are created on second surface 24 while first surface 22 has been subject to a printing operation to present an advertising display.

The creation of joint segments 42 and 44 in conjunction with cohesive zones 32 and 34 enables convenient handling of display 20 prior to final setup. Because cohesive zones 32 and 34 are not naturally opposed to one another prior to manipulation of the display and because these zones are on one side of display 20 (they are present on the same surface), multiple blanks can be stacked and any required manipulation of display 20 can be carried out without unintentional bonding of the blanks to each other, or portions of a blank to itself. Only when a user bends the blank at joint segments 42 and 44 will cohesive zones 32 and 34 be in opposition and ready for engagement.

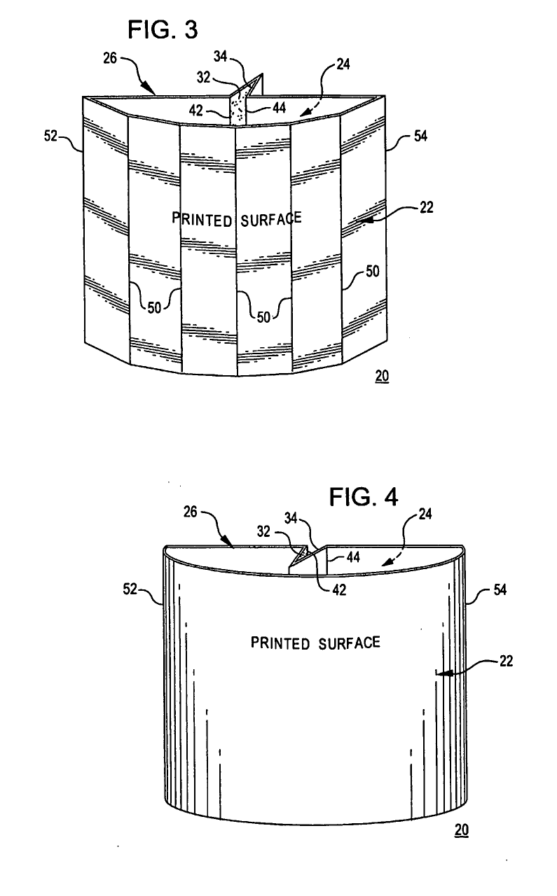

As noted earlier, joint segments 52 and 54 are also present. These joint segments permit display 20 to be formed into a three dimensional form other than a simple hollow cylinder; in the case of FIG. 1, the form is a half-hollow cylinder (also referred to as a curvilinear display). If different surface characteristics are desired, additional joint segments can be introduced. For example, FIG. 2 shows the introduction of joint segments 56 and 58 to form an irregular polygon (or roughly a half-hollow hexagon). Additional multifaceted rectilinear displays can be formed through the introduction of additional joint segments 50 as is illustrated in FIG. 3. Of course, each joint segment 50 need not be of equal angle; the illustrated display is intended for approximately 180° viewing.

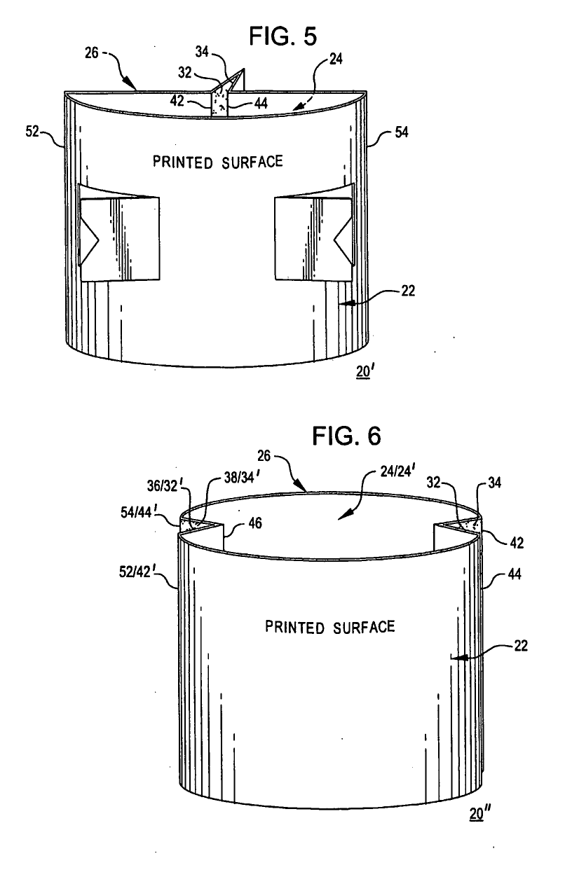

If cohesive zones 32 and 34 are established on first surface 22, joint segments 42 and 44 will again be used, however, the direction of pivot will be reversed from that of FIGS. 1-3. This second series embodiment configuration is shown in FIG. 4. Another adaptation of the first series embodiment is shown in FIG. 5 wherein conventional cutouts are used to further enhance the presentation of display 20′. In all other respects, the embodiment of FIG. 5 is similar to that of FIG. 1.

The third series embodiment shown in FIG. 6 demonstrates two alternative approaches to constructing the illustrated display 20″. As noted above, the incorporation of multiple blanks is contemplated. Thus, the obverse “Printed surface” blank and the reverse “Printed surface” blank may be joined together at cohesive zones 32-34 and 32′-34′. Alternatively, a single blank can be used where cohesive zones 36 and 38 are separated by joint segment 46. In this arrangement, it is clear that cohesive zones need not be adjacent opposite ends of the blank but may be placed anywhere there between and utilized for novel display arrangements.

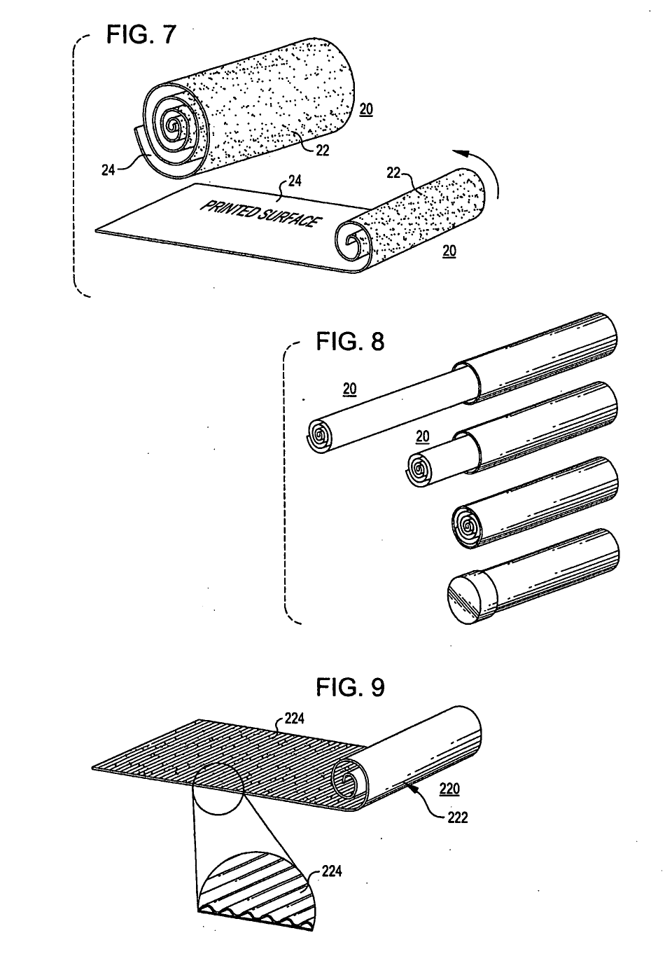

While it was noted earlier that for bulk shipment of display 20, numerous blanks could be bundled in a stacked configuration, use of a cohesive as the attachment means also facilitates convenient shipment of small numbers of displays. As best shown in FIGS. 7 and 8, application of a cohesive to the entire area of first surface 22 still permits one to roll display 20 to approximate a solid cylinder. Because the cohesive will not bond or otherwise engage second surface 24, which preferably includes imprinted graphics, display 20 is not adversely affected by this packaging procedure. Moreover, this form of packaging beneficially isolates first surface 22 from incidental contact with itself, which would cause undesired bonding to take place.

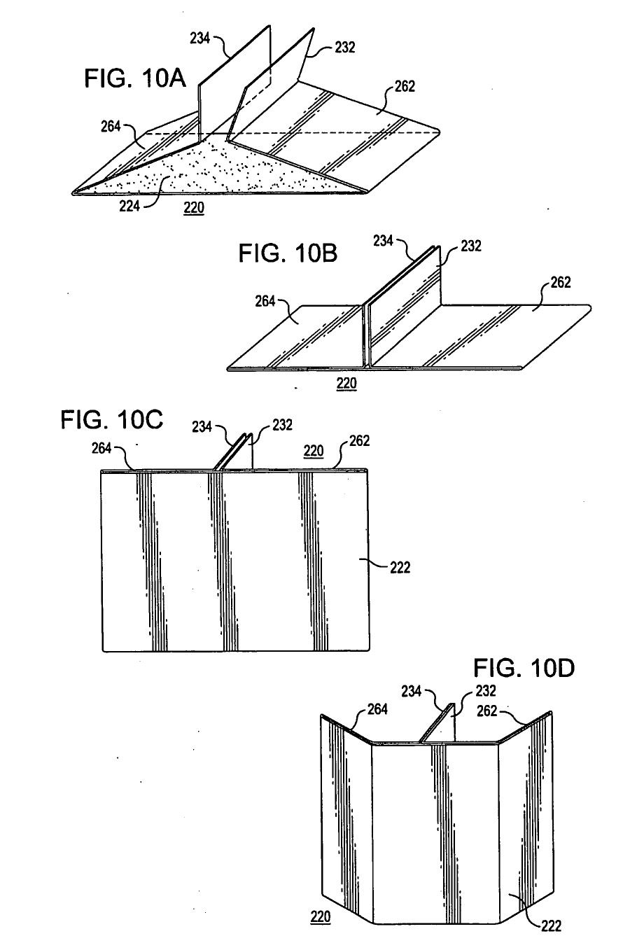

A fourth series of embodiments, an example of which is illustrated in FIG. 9, uses a single face corrugated material for display 220. Graphics are applied to first surface 222, which is the planar single face, while the cohesive is applied to second surface 224, which is the corrugated face. The advantages associated with the use of this material derive from both manufacturing efficiencies as well as usability metrics. Single face corrugated material of the type shown in FIG. 9 is flexible by nature in the major axis (longitudinal) while highly rigid in the minor axis (lateral). This combination of features permits convenient packaging of the display such as by rolling while creating a display having high rigidity when deployed. Moreover, the longitudinal flexibility will often dispense with the need for production scoring of the material since localized bending joints are present at each root of the fluted layer. When used in combination with a full cohesive coating on second surface 224, a user can establish a desired 3-D form, and fold the material back upon itself to preserve the desired form. FIGS. 10A-C illustrates an assembly of a 3-D display using the material shown in FIG. 9. In FIG. 1A, the desired geometry of the display is created and sides 262 and 264 are folded back onto themselves. To provide sufficient stability, ends 232 and 234 are joined as previously described with respect to earlier embodiments (FIG. 10B), where after the desired display 220 is created. FIG. 10D illustrates a resulting display having a curvilinear face.

From a manufacturing perspective, the fourth embodiment may be constructed by first imprinting one side of first surface 222, applying a cohesive coating to one side of second surface 224, and securely bonding the unprinted side of first surface 222 to the untreated side of second surface 224 while simultaneously imparting a corrugated or fluted configuration there to.

What is claimed:

1. A three dimensional structure comprising:
a blank of material having a first surface, a second surface, a first end in opposition to a second end, and a perimeter wherein one of the first surface or the second surface comprises a first and a second attachment zone, each comprising an attachment means, and wherein the first and second attachment zones are separated by an area not comprising attachment means.

2. The structure of claim 1 wherein the first and the second attachment zones are in contact with each other

3. The structure of claim 1 wherein the material further comprises a plurality of joint segments.

4. The structure of claim 3 wherein the joint segments are one of perforations or scores.

5. The structure of claim 1 wherein the side opposite the side comprising the first and second attachment means comprises graphics.

6. The structure of claim 1 wherein the side comprising the first and second attachment means further comprises graphics in the area there between.

7. The structure of claim 1 wherein the material further comprises at least one cut-out.

8. The structure of claim 2 wherein the resulting structure is characterized as curvilinear.

9. The structure of claim 2 wherein the resulting structure is characterized as rectilinear.

10. The structure of claim 1 wherein the attachment means comprises a cohesive.

11. A three dimensional structure comprising:
a blank of material having a first surface, a second surface, a first end in opposition to a second end, and a perimeter wherein the first surface is generally smooth, and the second surface is generally fluted and comprises an attachment means.

12. The structure of claim 11 wherein the first surface comprises graphics.

13. The structure of claim 11 wherein a portion of the second surface between the first end and the second end is in contact with itself.

14. The structure of claim 11 wherein the first end and the second end are in contact with each other.

15. The structure of claim 11 wherein substantially all portions of the second surface are in contact with itself.

16. The structure of claim 11 wherein substantially all portions of the second surface comprises an attachment means.

17. The structure of claim 16 wherein the first surface comprises graphics.

18. The structure of claim 16 wherein a portion of the second surface between the first end and the second end is in contact with itself.

19. The structure of claim 16 wherein the first end and the second end are in contact with each other.

20. The structure of claim 16 wherein substantially all portions of the second surface are in contact with itself.

21. The structure of claim 11 wherein the attachment means comprises a cohesive.
